(19) United States
(12) Patent Application Publication
(10) Pub. No.: US 2007/0043603 A1
(43) Pub. Date: Feb. 22, 2007

(54) Electronic marketplace for identifying, assessing, reserving and engaging knowledge-workers for an assignment using trade-off analysis

(75) Inventors: Eric Michael Andersen, Natick, MA (US); Christine Ann Atkinson, Denver, CO (US); Arthur Ciccolo, Ridgefield, CT (US); Patrick Howard, Katonah, NY (US); Thomas A. Stachura, Wheaton, IL (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/204,815

(22) Filed: Aug. 16, 2005

(51) Int. Cl. G06F 9/46

(52) U.S. Cl. 705/9

(57) ABSTRACT

A method and system for matching a knowledge worker to a selecting entity's needs according to a system of codes corresponding to pre-defined rules of engagement. The rules of engagement include, but are not limited to, experience levels, salary, geographic location, job starting date and duration, and industry sector. If a search of knowledge workers fails to match an available worker with a job need of the selecting entity, the selecting entity posts a job posting on a website maintained by a third party administrator who maintains webpages that are accessible only to screened job applicants.

### BACKGROUND OF THE INVENTION

1. Technical Field

The present invention relates in general to the field of computers, and in particular to computers used to match human resources to a buyer's needs. Still more particularly, the present invention relates to a method and system that allows the buyer to qualitatively and quantitatively match her needs for one or more workers according to dynamically assigned parameters.

2. Description of the Related Art

In recent years, the professional and IT services market has become global. With advancements in communication infrastructures, collaboration technologies and international trade agreements, certain work historically sourced in one country can be easily and readily addressed by a skilled professional in another country. The global marketplace has created new challenges for the planning and management of human resource capacity in companies. With the globalization of the services markets, firms are finding both an opportunity and a threat. While the economic price points for the provisioning of services is declining, the risk of delivery due to staffing geographically dispersed teams is higher.

Furthermore, the creation and enablement of a professional network within or across enterprises provides significant benefits and value to organizations. Some 48 million of the 137 million workers in the Unites States alone can be classified as “knowledge workers.” A single company, like IBM or pharmaceutical firms, can employ over 100,000 knowledge workers. It has been observed that the real value comes not from the management of knowledge but rather the creation and exchange of knowledge. Really valuable knowledge resides largely in the heads of talented employees.

### SUMMARY OF THE INVENTION

The present invention recognizes the need for an integrated business process and technology which enables trade-off analysis for staffing of knowledge workers to an assigmnent. Information from structured and unstructured information sources must be presented to the decision maker supported by business methods where trade-offs can be compared and reviewed side-by-side in order to make the optimum staffing decision.

The present invention is therefore an electronic marketplace for identifying, assessing, reserving and engaging knowledge-workers from an assortment of business units, world-wide geographic locations, enterprises or industry associations for an assignment. The marketplace permits the assessment and reservation of multiple team members on an assignment, and supports the posting of open requisitions for subsequent provisioning, if required, capturing detailed specification pertinent to the assignment. In like manner, in order to ensure efficient, predictable and consistent operation of the marketplace, the “rules of engagement” identify parties responsible for various risks incurred through the assignment, such as late cancellation of an assignment, currency fluctuation on cost rates, import duties for services, local taxes, travel and other fees. The rules of engagement also include, but are not limited to, experience levels, salary, geographic location, job starting date and duration, and industry sector. If a search of knowledge workers fails to match an available worker with a job need of the selecting entity (e.g., a hiring entity, a volunteer organization, etc.), the selecting entity posts a job posting on a website maintained by a third party administrator who maintains webpages that are accessible only to screened job applicants.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates a network that couples a server managed by a Professional Marketplace third party administrator (TPA) to client computers used by job seekers and selecting entities;

FIG. 2 depicts a relationship among the Professional Marketplace TPA, the job seekers and the selecting entities;

FIG. 3 is a high level flow chart showing steps taken in an exemplary embodiment of the present invention;

FIG. 4 illustrates an exemplary computer used by the server shown in FIG. 1;

FIG. 5 depicts an exemplary client computer used by either a job seeker or a selecting entity;

FIG. 6a illustrates a Graphical User Interface (GUI) provided to a selecting entity by the Professional Marketplace TPA;

FIG. 6b depicts a GUI having active fields that allow a selecting entity to post a job opening with the Professional Marketplace;

FIG. 6c illustrates a GUI showing a selecting entity a status of jobs being filled;

FIG. 7 depicts a GUI presented to a job seeker by the Professional Marketplace;

FIG. 8 depicts a GUI presented to a selecting entity to organize options according to location and cost of a worker;

FIGS. 9a-b show a high-level flow chart of steps taken to deploy software capable of executing the steps shown in FIG. 3;

FIGS. 10a-c show a high-level flow chart of steps taken to deploy in a Virtual Private Network (VPN) software that is capable of executing the steps shown in FIG. 3;

FIGS. 11a-b show a high-level flow chart showing steps taken to integrate into an computer system software that is capable of executing the steps shown in FIG. 3; and

FIGS. 12a-b show a high-level flow chart showing steps taken to execute the steps shown in FIG. 3 using an on-demand service provider.

### DETAILED DESCRIPTION OF THE PREFERRED EMBODIMENT

With globalization, many companies are looking to lower cost labor markets in countries such as India, China and Russia to remain competitive while reaching qualified knowledge workers for assignments. The use of subcontractors has also become more prevalent. The increased alternatives to staffing open positions have added to the complexity of finding the right person with the right skills (knowledge and experience) at the right cost for the job. In order to facilitate trade-offs among available resources for an assignment and to make resource staffing commitments, there is a strong requirement to achieve “information transparency” on skills, availability and cost.

The complexity resulting from global market pressures and the need to reach qualified talent is compounded by a lack of process and technical integration, at local business unit levels or across an enterprise. Each business unit within the global market often has a unique set of staffing processes and procedures, with limited visibility on experience, skills, availability, and cost. Privacy rules are complex, requiring knowledge about local regulations and disclosure rules governing an employees record. As a result, multiple, non-integrated systems must be searched independently in many companies. Then, the data must be aggregated and analyzed in order to accurately compare staffing alternatives. This current process is extremely inefficient in most organizations. More importantly, the skills and experiences of many professionals are catalogued within databases that are unstructured and are difficult to access or navigate. This is a significant problem which can prevent decision-makers from staffing assignments and making appropriate tradeoffs on availability and cost in a timely manner. The cost of unutilized and underutilized knowledge workers is significant (due to morale, delivery problems, attrition, cost of recruitment, client satisfaction and so on).

Decision-makers use a myriad of criteria to evaluate potential candidates for their available positions or client assignments. Trade-off analysis on skills, availability and cost must be performed to identify the optimum candidate to fill the assignment as well as to determine the best fit for the existing project team. Other considerations include the project requirements, the working environment, the organization and/or team culture, and the personalities and qualifications of current team members.

For example, when staffing a new role for an assignment, a project manager will take into account the nature of the skills which are already committed to the existing team. The synergy created by the team as a whole is considered in addition to the contributions and qualities of each team member as new team members are added. Furthermore, a project manager needs to be conscious of the budget. A decision-maker may perform a skills trade-off on an experienced candidate versus an inexperienced candidate based on economics of the new resource as well as availability. Assigning the experienced candidate to the team may result in an over-qualified team at a greater cost. On the other hand, the project manager may determine that a less experienced candidate can be mentored on the assignment, with no compromise in the quality of the results. This illustrates the type of trade-off analysis that occurs in staffing knowledge workers to an assignment.

Decision-makers must not only consider a knowledge-worker's skills but they must also perform trade-off analysis on the knowledge-worker's availability. Availability is an attribute which is dynamic and may change on short-notice. As a result, to make an effective decision, it is critical for the decision-maker to have access to accurate availability information on a real-time basis.

Decision-makers must also understand the project's requirements when evaluating availability. Some positions require a full-time commitment while others only require part-time dedication. In other situations, a decision-maker may only require one or two hours from a Subject Matter Expert with specific wisdom for advisory purposes. The nature of the assignment must also be assessed. One assignment may require a minimal amount of time to review a proposal remotely, and another assignment may entail a full-time commitment in an on-site client-facing delivery position. As a result, the decision-maker must perform analysis of the professional's availability against the requirements of the position.

Trade-offs on cost rates of knowledge-workers are also reviewed. In a global market, the price that a market will bear is calibrated by demand and the ease of access to qualified talent. In addition, the cost structure of the local labor markets, such as salaries, benefits, inflation and other factors, determines the cost rates that must be commanded by the professionals who are housed in that geographic location. The decision-maker will select best qualified talent for an assignment at the lowest cost-rate, based on a review of available skills worldwide.

Inconsistent and complex data structures mask the potential utility of resource information and necessitate a great deal of manual effort to maintain. Available data is often incomplete and outdated. Lack of data integrity reduces confidence in the data structure and decreases the value of the data for decision making.

Unclear rules of engagement in the staffing process also contribute to project staffing inefficiency. Multiple commitments of a labor pool resource due to breaks in communication can result in rework (i.e., restarting the staffing process) and impact client and/or organization/manager satisfaction.

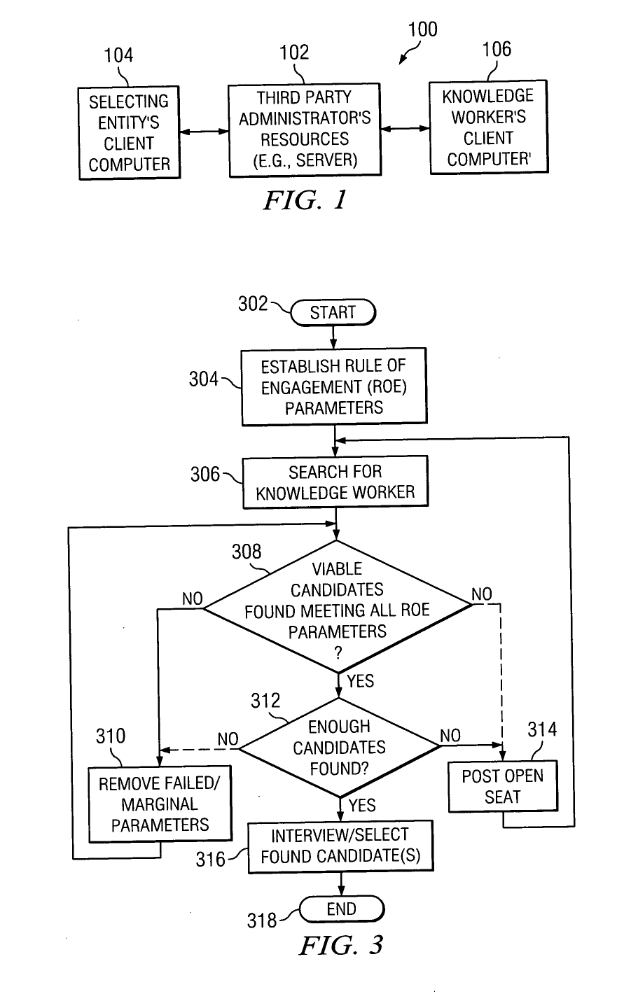

With reference now to the figures, and in particular to FIG. 1, there is depicted a high-level block diagram of a network system 100 in which the present invention may be utilized. A third party administrator's (TPA's) server 102 is communicatively coupled, preferably via the Internet, to a selecting entity's client computer 104 and a knowledge worker's client computer 106. The TPA's server 102 uses the present invention to bring together a selecting entity with a worker searching for a job position.

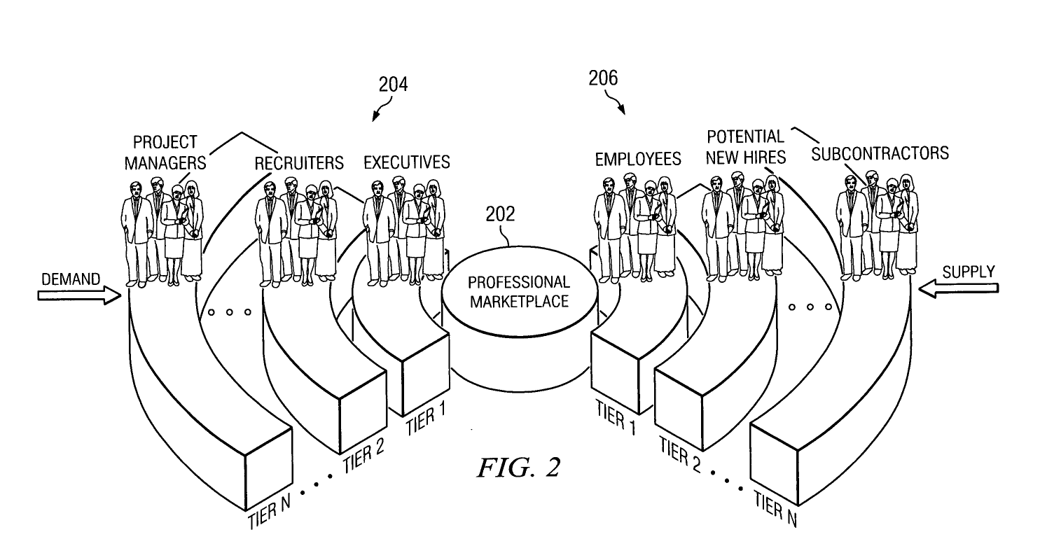

As shown in FIG. 2, a professional marketplace 202 (using TPA's server 102 shown in FIG. 1) brings together selecting entities 204 (which use selecting entity's client computer 104 shown in FIG. 1) and knowledge workers 206 (which use knowledge worker's client computer 106 shown in FIG. 1). As shown, the selecting entities 204 can be of different tiers, including but not limited to project managers, recruiters and enterprise executives. Similarly, the knowledge workers 206 may be from, but are not limited to, currently employees of the selecting entity 204, potential new hires, or subcontractors.

FIG. 2 depicts the Professional Marketplace as a platform which will support the assignment of resources on projects and/or proposal efforts. Optimization can occur by providing decision-makers with full visibility to staffing options which can be assessed via trade-off analysis. The information provided can be categorized and organized according to a pre-defined or dynamically defined set of objective variables as well as a set of constraints. In the simplest case, a user would specify max or min values for the variables and constraints, and the system would search for candidates which met the criteria. Solutions would be ranked according to primary, secondary and n-ary keys. More sophisticated mathematical techniques such as linear or non-linear programming can automatically utilize the user-specified variables to find only those set of solutions which were feasible, then narrow the set to the optimal. The system can then allow the user to relax one or more constraints to explore other solution options. By providing relevant buying decision information, the marketplace enables faster and more profitable staffing decisions that meet the needs of projects, proposals or organizations. At the same time, organizational, process and technology changes are implemented to support the marketplace. The marketplace establishes Rules of Engagement which result in a productive marketplace where demand (decision-makers) and supply (knowledge-workers) can be brought together to meet common goals regardless of organizational or geographical boundaries.

The Professional Marketplace enables information visibility and transparency in order to leverage available supply and demand up to a global level. The present invention provides an incentive to maintain data integrity so information in the marketplace is up-to-date and real-time. Knowledge-workers are responsible for registering themselves in the marketplace as well as for keeping their information updated. In a preferred embodiment, the present invention uses standardized resource “currency” or information in order to make like comparisons regardless of geographic and organizational boundaries. Data integrity and standardization thus promote effective and efficient staffing decisions in a swifter, more lucrative manner.

Thus, FIG. 2 provides an overview of the electronic Professional Marketplace. Buyers (demand) and Sellers (supply) may vary depending on the dynamics and needs of a specific organization.

The trade-off analysis supported by the marketplace empowers decision-makers to compress the cycle time taken to staff a knowledge-worker. The decision-maker is able to establish buying criteria, evaluate staffing alternatives, select the optimal candidate and assign a resource more productively and proficiently. Simultaneously, the marketplace consolidates the disparate, unstructured supply data describing various knowledge-workers from different labor pools in one website containing all relevant buying data. The supply alternatives considered by decision-makers are expanded, and they are thus able to shorten the time taken to complete the identification, reservation and assignment processes. The present invention thus incorporates the commitment of resources through either the use of an individual, such as a Deployment Manager, or through a computer.

The Professional Marketplace can be configured to update knowledge-worker data from the respective data source depending on organizational requirements. For instance, an organization may have the requirement to update resource skills data from one source on a weekly basis, but cost data may need to be refreshed from a different source on a daily basis. This flexibility allows this same solution to conform to the needs of different organizations and industries.

The Professional Marketplace preferably uses faceted searching and browsing to give users an effortless and efficient mechanism to review and compare alternative staffing options. Faceted searching is a powerful search method using the combination of Boolean operators and parenthesis to perform specific and advanced searches. Faceted browsing supports information foraging which integrates navigation with search results. Through the use of faceted search and discovery in the marketplace, the user can quickly navigate through knowledge-worker categories to view candidates that meet their needs. Users can easily widen or narrow their search criteria to pull up a certain amount of matching candidates for trade-off analysis. In addition to simple faceted search, wherein predefined labeled fields in a document are used to focus the search, the system can employ Information Extraction techniques such as string matching, named entity and relationship extraction to analyze the free text in documents in order to identify and label items as mentions of specific concepts. Examples may include resumes, articles, speeches, white-papers or books. This capability allows the system to not only support key word and fielded search, but semantic or conceptual search as well. For example, if a resume mentions Swiss Air, the analysis could label that as a mention of an “AIRLINE”. A semantic search on resumes for the concept “AIRLINE” would return this resume even though the key word or fields do not contain that specific term.

Note that the Professional Marketplace 202 is able to establish Rules of Engagement (ROE), common resource currency, governance requirements, and marketplace efficiency. The ROE include, inter alia, where a job is located, when the job is scheduled to start and end, what the job pays, and what qualifications are required of the person(s) to be hired. The common resource currency uses a standard code (analogous to a Standard Industrial Code—SIC, but having greater detail and granularity) to describe and categorize job openings. The governance requirements include which field are mandatory when looking for a worker or when looking for a job. The marketplace efficiency is based on how quickly jobs are filled, and in particular how quickly jobs that require scarce labor resources are filled. This efficiency can be used to determine how the service running the Professional Marketplace 202 is paid (i.e., difficult jobs that are quickly filled may result in a contractual bonus to be paid to the service).

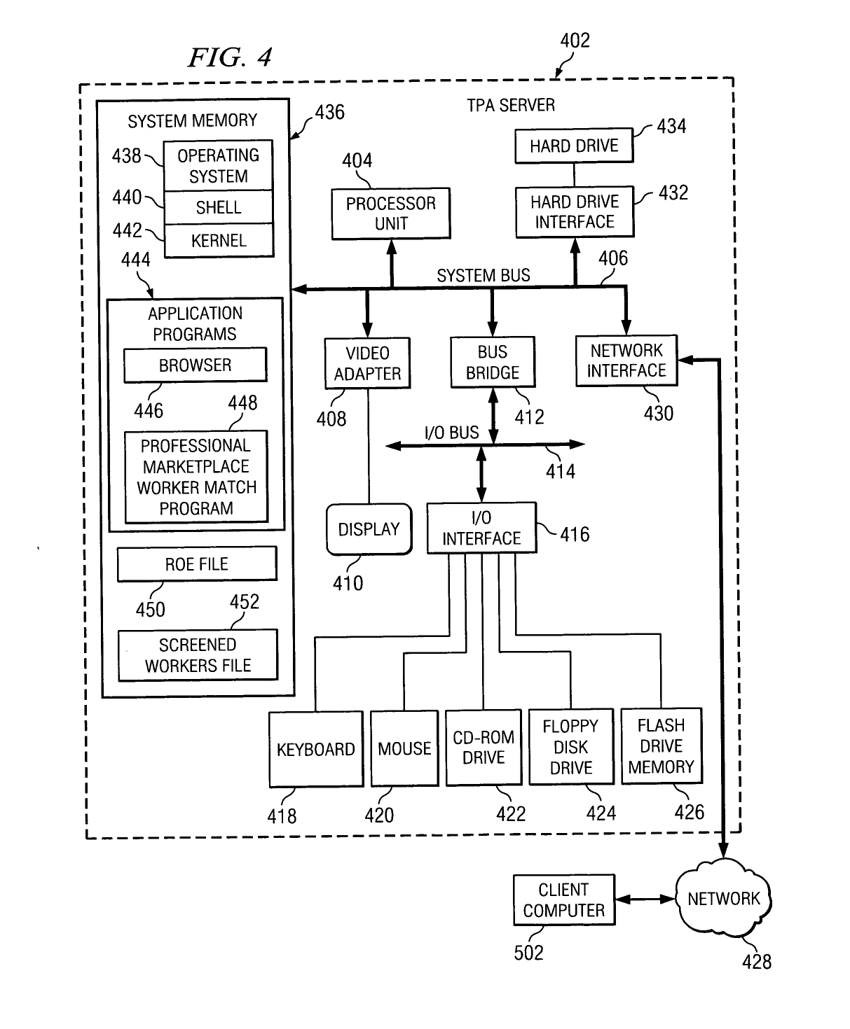

With reference now to FIG. 3, there is depicted a flow-chart of high-level steps taken in the present invention. After initiator block 302, rules of engagement (ROE) parameters are established with the professional marketplace in the TPA server (block 304). These rules include, but are not limited to, the job qualifications and requirements of the potential new worker (e.g., specialized training, years experience) as well as a description of the job position being filled (e.g., location, salary, length of assignment).

A search for a matching candidate is then performed (block 306), as described in further detail below. If a viable (e.g., being available, qualified and meeting pay and geographic locale requirements) candidate matching all of the ROE requirements is not found (query block 308), then the failed or marginal (meeting some but not all of the sub-units of a parameter) parameters are removed (block 310), in order to expand the search zone. Alternatively, if enough viable candidates are not located, than a job posting of an open seat can be performed (block 314). If one or more candidates are found that meet the ROE requirements, then a query is made (query block 312) to determine if enough candidates have been found. If not, then an open seat is posted (block 314), or alternatively additional failed/marginal parameters are removed to allow for additional candidates to be selected (block 310). When an adequate number of candidates are located, they are interviewed and/or selected (block 316), and the process ends (terminator block 318).

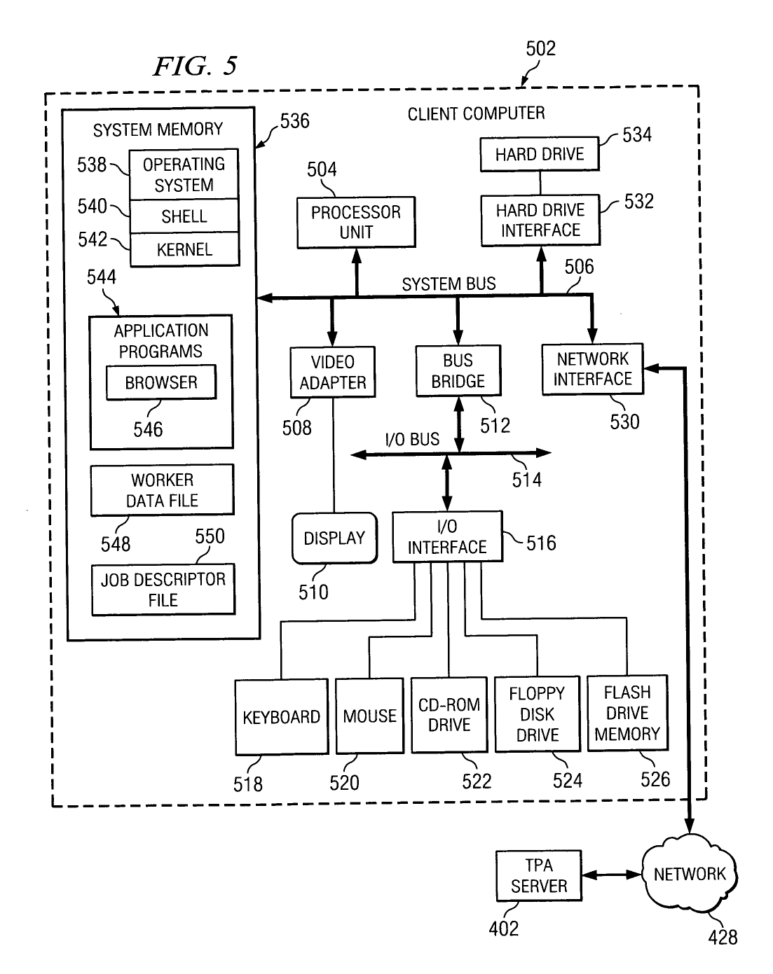

With reference now to FIG. 4, there is depicted a block diagram of an exemplary TPA server 402 that can be used by the professional marketplace 202 described above, or alternatively (and more specifically) as a TPA's resources 102 described above. TPA server 402 includes a processor unit 404 coupled to a system bus 406. Also coupled to system bus 406 is a video adapter 408, which drives/supports a display 410. System bus 406 is coupled via a bus bridge 412 to an Input/Output (I/O) bus 414. Coupled to I/O bus 414 is an I/O interface 416, which affords communication with various I/O devices, including a keyboard 418, a mouse 420, a Compact Disk—Read Only Memory (CD-ROM) drive 422, a floppy disk drive 424, and a flash drive memory 426. The format of the ports connected to I/O interface 416 may be any known to those skilled in the art of computer architecture, including but not limited to Universal Serial Bus (USB) ports.

TPA server 402 is able to communicate with a client computer 502 via a network 428 using a network interface 430, which is coupled to system bus 406. Preferably, network 428 is the Internet.

Also coupled to system bus 406 is a hard drive interface 432, which interfaces with a hard drive 434. In a preferred embodiment, hard drive 434 populates a system memory 436, which is also coupled to system bus 406. Data that populates system memory 436 includes TPA server 402's operating system 438, which includes a command interpreter program known as a shell 440, which is incorporated in a higher level operating system layer and utilized for providing transparent user access to resources such as application programs 444, which include a browser 446, a Professional Marketplace Worker Match Program 448, as well as data files including but not limited to a Rule of Engagement (ROE) file 450 and a screened workers file 452.

As is well known in the art, a command interpreter or “shell” is generally a program that provides an interpreter and interfaces between the user and the operating system. More specifically, a shell program executes commands that are entered into a command line user interface or from a file.

The shell (UNIX) or command processor (Windows) is generally the highest level of the operating system software hierarchy and serves as a command interpreter. The shell typically provides a system prompt, interprets commands entered by keyboard, mouse, or other user input media, and sends the interpreted command(s) to the appropriate lower levels of the operating system (e.g. a kernel 442) for processing.

Exemplary application programs 444 used in the present invention are web browser 446 and Professional Marketplace Worker Match Program 448. Web browser 446 includes program modules and instructions enabling a World Wide Web (WWW) client (i.e., client computer 502) to send and receive network messages to the Internet using HyperText Transfer Protocol (HTTP) messaging. Professional Marketplace Worker Match Program 448 creates and manages a database of available workers and jobs, as well as Graphical User Interfaces (GUIs) used in the present invention.

ROE file 450 includes a listing of jobs available, as well as their requirements and features. ROE file 450 also includes data related to workers available for hire, and their qualifications, in accordance with the present invention.

One of the features of Professional Marketplace Worker Match Program 448 is that potential workers can be pre-screened by the Professional Marketplace. This screening may be performed automatically or manually, and is done to confirm that personal and/or professional background data claimed by the potential worker is accurate. When the data is confirmed as accurate (or when anomalies are found), this information is stored in screened workers file 452 for access by Professional Marketplace Worker Match Program 448. Preferably, only screened workers are authorized to view jobs posted by the selecting entities.

The hardware elements depicted in TPA server 402 are not intended to be exhaustive, but rather are representative to highlight essential components required by the present invention. For instance, TPA server 402 may include alternate memory storage devices such as magnetic cassettes, Digital Versatile Disks (DVDs), Bernoulli cartridges, and the like. These and other variations are intended to be within the spirit and scope of the present invention.

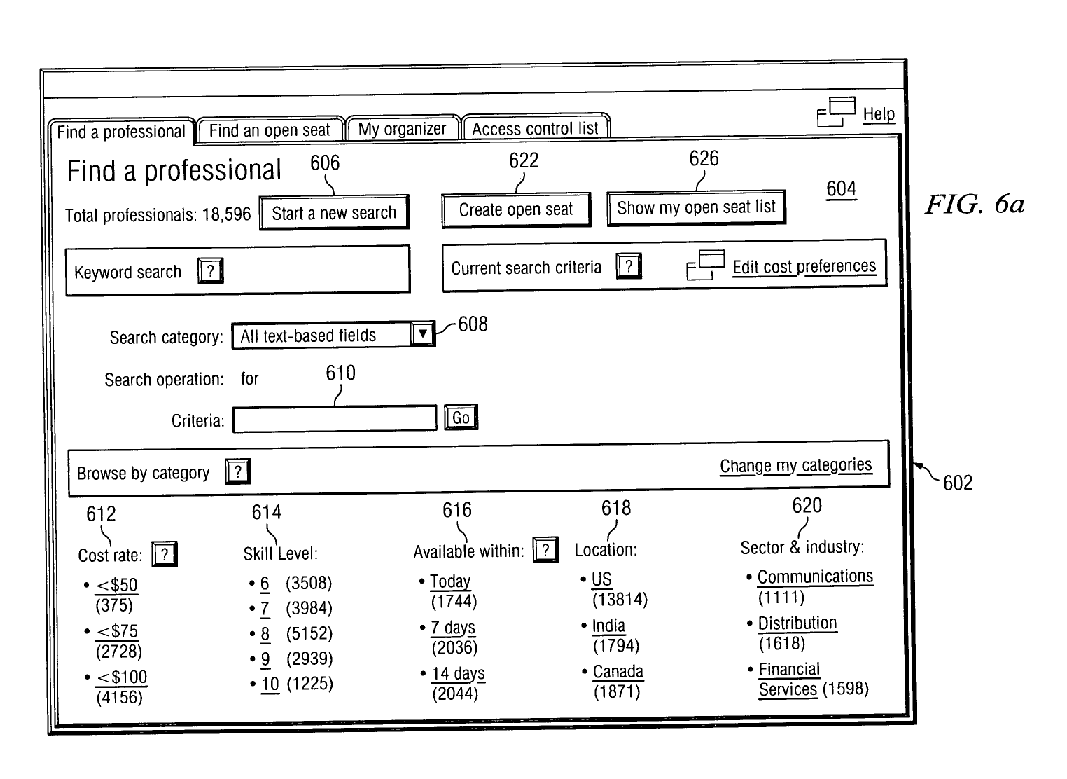

With reference now to FIG. 5, there is depicted a block diagram of an exemplary client computer 502, which is an exemplary computer for either selecting entity's client computer 104 or knowledge worker's client computer 106 shown in FIG. 1. Client computer 502 includes a processor unit 504 coupled to a system bus 506. Also coupled to system bus 506 is a video adapter 508, which drives/supports a display 510. System bus 506 is coupled via a bus bridge 512 to an Input/Output (I/O) bus 514. Coupled to I/O bus 514 is an I/O interface 516, which affords communication with various I/O devices, including a keyboard 518, a mouse 520, a Compact Disk—Read Only Memory (CD-ROM) drive 522, a floppy disk drive 524, and a flash drive memory 526. The format of the ports connected to I/O interface 516 may be any known to those skilled in the art of computer architecture, including but not limited to Universal Serial Bus (USB) ports.

Client computer 502 is able to communicate with TPA server 402 via network 428 using a network interface 530, which is coupled to system bus 406.

Also coupled to system bus 506 is a hard drive interface 532, which interfaces with a hard drive 534. In a preferred embodiment, hard drive 534 populates a system memory 536, which is also coupled to system bus 506. Data that populates system memory 536 includes client computer 502's operating system 538, which includes a shell 540 and a kernel 542, for providing transparent user access to resources such as application programs 544, which include a browser 546. Optionally, client computer 502, if used as knowledge worker's client computer 106, can hold a worker data file 548 that contains, inter alia, a copy of or a link to a specific worker's resume as well as any publications, published patents, etc. Worker data file 548 is available for data mining by Professional Marketplace Worker Match Program 448 described above.

Similarly, if client computer 502 is used as selecting entity's client computer 104, system memory 536 may include a job descriptor file 550, which describes job posting needed by a selecting entity, and which may be data mined by Professional Marketplace Worker Match Program 448.

The hardware elements depicted in client computer 502 are not intended to be exhaustive, but rather are representative to highlight essential components required by the present invention. For instance, client computer 502 may include alternate memory storage devices such as magnetic cassettes, Digital Versatile Disks (DVDs), Bernoulli cartridges, and the like. These and other variations are intended to be within the spirit and scope of the present invention.

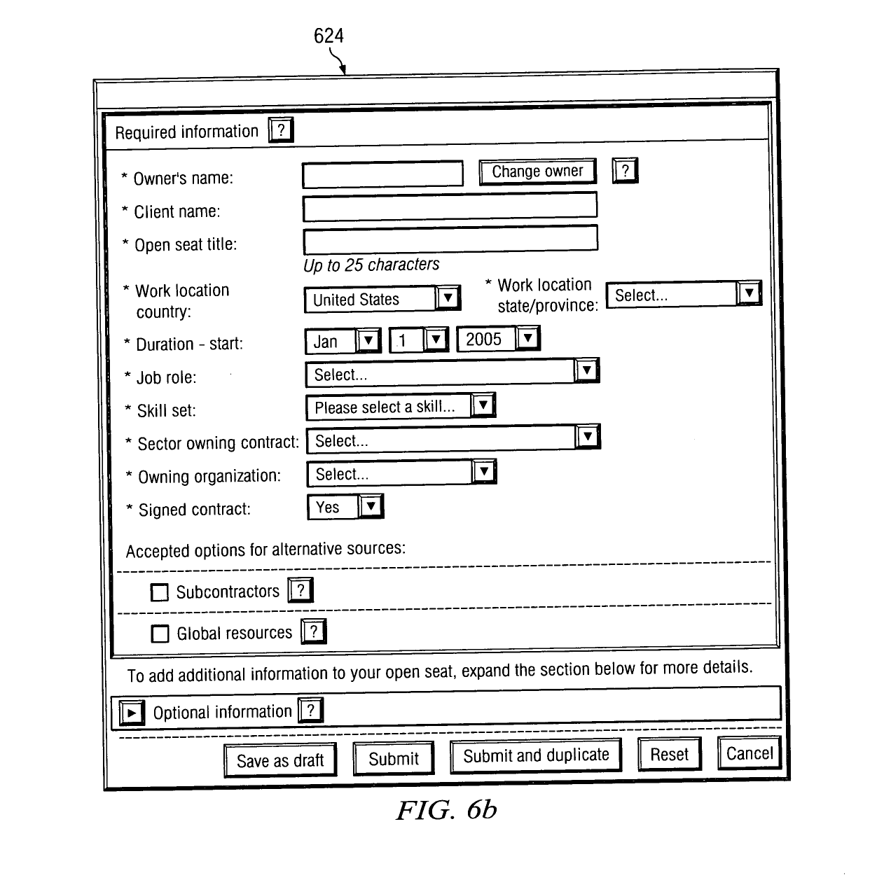

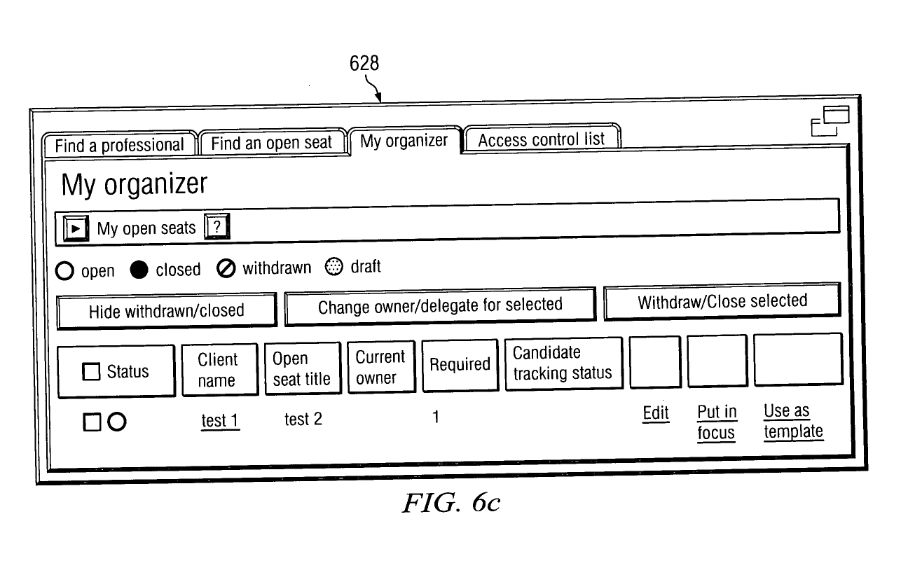

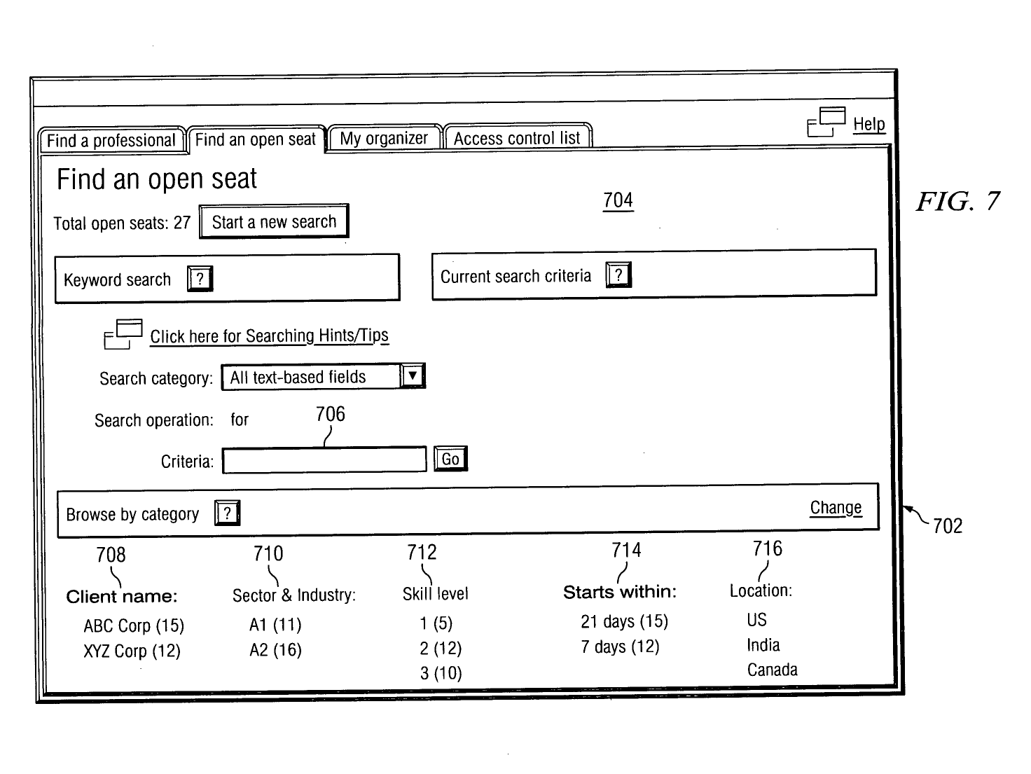

Referring now to FIG. 6a, a Graphical User Interface (GUI) 602 generated by Professional Marketplace 202 is depicted. Note that tab 604 has been selected, thus pulling up the webpage that enables a selecting entity to “Find a Professional.” By clicking field 606, a new search for a worker is initiated. The search, under the control of the Professional Marketplace 202 shown in FIG. 2, allows the selecting entity to perform a Boolean search based on multiple parameters. For example, field 608 has allowed a text search to be performed on “All text-based fields” using search text typed into a criteria field 610. Thus, Professional Marketplace 202 can search for all written or linked data associated with worker candidates, including their resumes, publications, etc.

Another option available, either with or without a text search as just described, is to select a Boolean search of various pre-set parameters, including a cost rate (job salary) 612, a band (years of experience) 614, a (worker) availability window 616, a (job) location 618, and a sector/industry 620. Note that GUI 602 is preferably presented after the selecting entity has entered which common resource currency (standardized code describing a knowledge worker's skillset—such as “SAP programmer,” “IC Test Engineer”, etc.).

If an unacceptably low number of workers are identified by the process just described, then the selecting entity can change some of the search parameters. For example, assume that the selecting entity clicked a hot button “10” under band 614, indicating the need for a worker with 10 years of experience. If the selecting entity is not satisfied with the number or names of workers identified having this experience, then the selecting entity can choose “8” to broaden the field of search. Alternatively, a parameter can be ignored entirely, such that all workers are chosen according only to the remaining non-ignored parameters.

If after performing a search for a worker, the selecting entity may decide that nobody in the database meets her needs. Therefore, she may click button 622, allowing her to post a job opening through the use of a page such as shown in GUI 624 shown in FIG. 6b. The selecting entity must fill out all fields having an “*” in accordance with the governance requirements of the Professional Marketplace 202.

After finding and choosing one or more worker candidates, the selecting entity can click button 626, allowing an organizer page, such as shown in GUI 628 in FIG. 6c, to be displayed. The organizer page shows which candidates are being considered for which jobs.

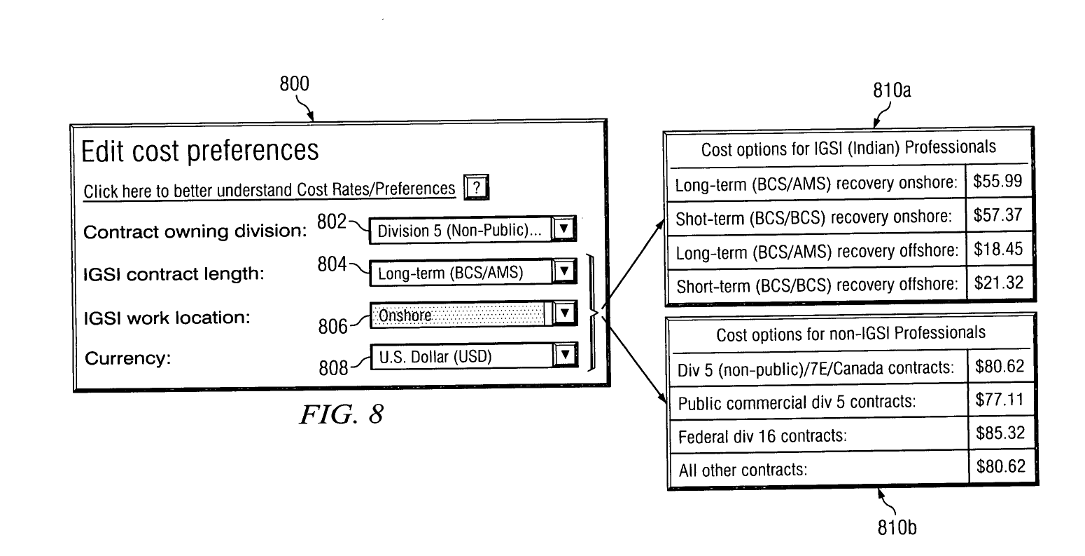

While the invention focuses on a selecting entity locating a knowledge worker, the knowledge worker can also locate a selecting entity through Professional Marketplace 202, which can generated on the knowledge worker's client computer 106 a GUI 702, shown in exemplary form in FIG. 7. Clicking hot button 704 has caused the “Find an open seat” option to appear, allowing the worker to search for a job according to a text search based on text entered into an input field 706, as well as performing a Boolean search on fields such as client name 708, requested service and industry area 710, requested skill level 712, starting date 714, and location 716. A “hit” based on the entered/selected fields will return a name and contact to be returned to the searching worker, or alternatively the searching worker's identity and contact information are returned to the selecting entity (either with or without the searching worker knowing who is receiving information on him).

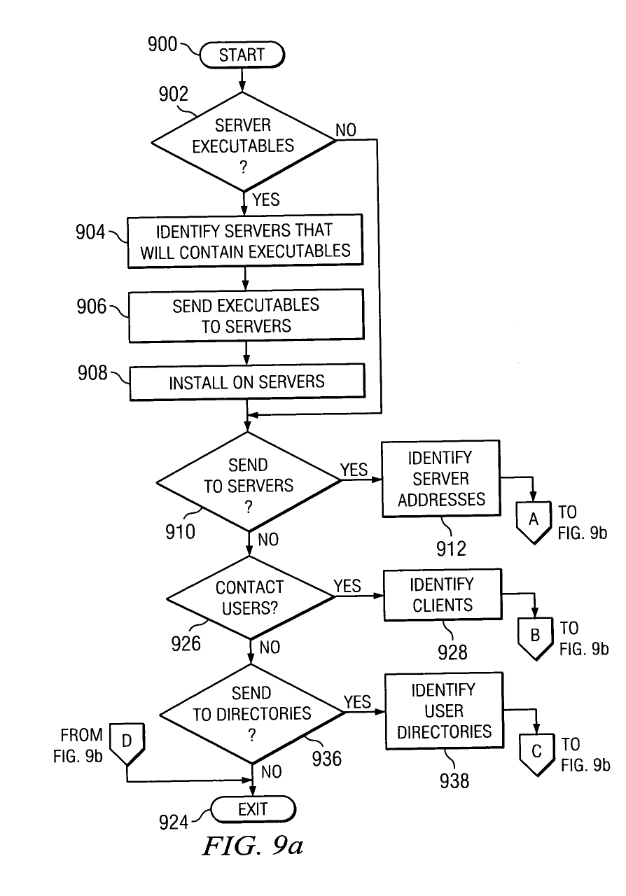

With reference now to FIG. 8, an exemplary GUI 800 is shown, which displays options available to a selecting entity to organize hiring options. For example, drop-down window 802 presents options to organize an employee search according to different enterprise divisions; drop-down window 804 present options to organize the employee search according to whether the job to be filled is long-term or short-term; drop-down window 806 present options for whether the employee will be onshore (U.S. based) or offshore (including multiple options from which the prospective employee may be located and/or a citizen); and drop-down window 808 presents the options of displaying salary costs of the prospective employee in different currencies. Upon selecting preferred options from each of the windows 802-808, GUI 800 (on the same or another window) presents window 810 (810a and/or 810b), which shows how much an employee will cost according to the length of the assignment and whether the employee is in the US or offshore. In the exemplary window 810, the options selected present costs of both onshore and offshore employees for short and long-term assignments.

The present invention provides the ability to easily and quickly identify knowledge resources from different labor pools, compare those resources, and trade-off on skills, availability and cost in order to make the most efficient staffing decision. Trade-off analysis is the kernel for creating an effective knowledge-worker marketplace. The invention uses technology to mask the complexity of identifying and assigning resources in the short-term, and then expands and refines the processes in the long-term based on a “Marketplace” concept. A web-based application with advanced faceted search engine capabilities is used to pull real-time talent pool data from various data sources into one collective venue allowing users to conveniently search and compare knowledge-workers from different labor pools adjacently. The ease of performing trade-off analysis in the electronic marketplace permits the decision-maker's arrival at an effective decision in an efficient amount of time.

The immediate advantages of this solution revolve around the speed of decision making, self-service, and precision. The increased visibility to unstructured data in a user-friendly fashion greatly decreases the amount of time needed to make a decision. The marketplace enables the integration of multiple disparate data sources through the use of advanced search capabilities and a common data dictionary. The decision-maker will have one common environment to access all relevant resource pool information necessary to make project assignment decisions. The ability to streamline the decision making process will result in faster, more profitable, and more effective assignments. Consequently, the closure of open positions will be accelerated minimizing lost revenue and increasing productivity. At the same time, customer satisfaction will increase and morale of knowledge workers participating the market and looking for assignment.

The marketplace provides a self-service solution for decision makers. A decision maker will view independently the wealth of information recorded on the knowledge worker without dependency. In addition, where subjective information is needed, such as past performance on specific assigmnents or work-style, the decision maker is provided with contact information on supervisors and other personal references. The decision-makers know the requirements of their team and their assignment better than anyone else, so their direct involvement in analyzing knowledge-worker characteristics will lead to a more effective decision.

Decision-makers are able to solve the challenge of building a team with complementary skills to deliver on the requirements of the project. This can be accomplished because of more precise, detailed information that is available to the decision-maker on the skills of the knowledge workers, such as “mastery levels” on defined competencies, drawn together from various information sources. With improved insight on the skills of a professional, and the associated cost rates and availability, a decision maker staffing an assignment can make the tradeoffs that are many times required in staffing a project with a multi-disciplinary. The marketplace allows for the matching of resource demand (in the form of staffing requirements) against supply (in the form of knowledge workers) through the trade-off analysis of work experience, skills, cost and availability. The invention establishes a marketplace forum which encompasses rules of engagements, policies as well as practices to enable an open market among various buyers (or decision-makers) and sellers (knowledge-workers or service providers).

Resource data is aggregated or accessed from multiple incongruous sources into one user-friendly and transparent marketplace application. As a result, decision-makers can view different resource supply data via a search engine in a single marketplace which they would otherwise have to sort through in various data sources, such as spreadsheets, databases, and web-applications. This invention supports a single integrated view of the data regardless of its location and format (i.e. virtualization of the information).

The present invention allows users to save a knowledge-worker record or groups of knowledge-workers records to be recalled and reviewed at a later time. These saved records can be displayed within a view of the marketplace called “My Selections”. The “My Selections” view is used by decision-makers in conjunction with the faceted search to add or delete search parameters to either expand or narrow their field of search. A large number of search parameters can be used to identify appropriate candidates based on a screen of unstructured information. Examples of unstructured information could include resumes, publications, lectures, audio recordings or videos.

The Marketplace endows users with a powerful means of rapidly limiting or expanding their field of search against a database of unstructured information facilitating trade offs around skills, costs and availability. Decision-makers can measure skill qualifications of candidates against client or project criteria, against the skill levels of existing team members and against skill competence and profiles in general. Comparisons between the skills and experiences of potential candidates can be performed to determine which candidate is the most qualified for the assignment as well as the best fit for the team as a whole. Where very large numbers of candidates need to be evaluated and the tradeoff variables are fuzzy, an inference engine could augment the mathematical programming tools to help winnow the field to a tractable number.

The Marketplace has the ability to vary pricing and effectively engage in spot market pricing at the global level. The reason for variable pricing may be due to the fluctuation of availability of a specific skill or the changing demand for certain expertise. Variable pricing mechanisms can be applied in the Marketplace depending on these and other factors. Cost rates for knowledge-workers can be calculated according to market demand. They can also be set by supply owners.

Decision-makers can perform trade-offs on cost to find a candidate which delivers their resource requirements at an acceptable and profitable price. Again, the tradeoffs may be performed simply through inspection, or by utilizing a spectrum of tools ranging from simple spread sheet models, to linear and non-linear programming, to logical inferencing.

Decision-makers must also consider availability of resources. They are able to narrow their search results based on resource availability suitable to the assignment. Concurrently, knowledge-workers are accountable for ensuring the accuracy of their availability. Through the marketplace, decision-makers trade-off the availability of resources in order to staff a candidate who fulfills their requirements according to the project schedule. A temporary reservation could be placed on a resource by utilizing the equivalent of a database lock on potential candidates within a specified time of there current availability date. This would be equivalent to a two phase commit in a transaction processing system in order to ensure a candidate who is the subject of multiple staffing investigations, is not committed to more than one buyer.

As a result, the invention provides a unique way of facilitating the conclusions of the decision-maker by balancing the trade-off analysis of skills, availability and cost. The marketplace makes the appropriate choice evident to the decision-maker without a burdensome or complex process. An electronic marketplace facilitating the trade-off analysis of cost, skills and availability is a Win/Win solution for both buyers (demand, regardless of geography or organization) and sellers (available supply).

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Software Deployment

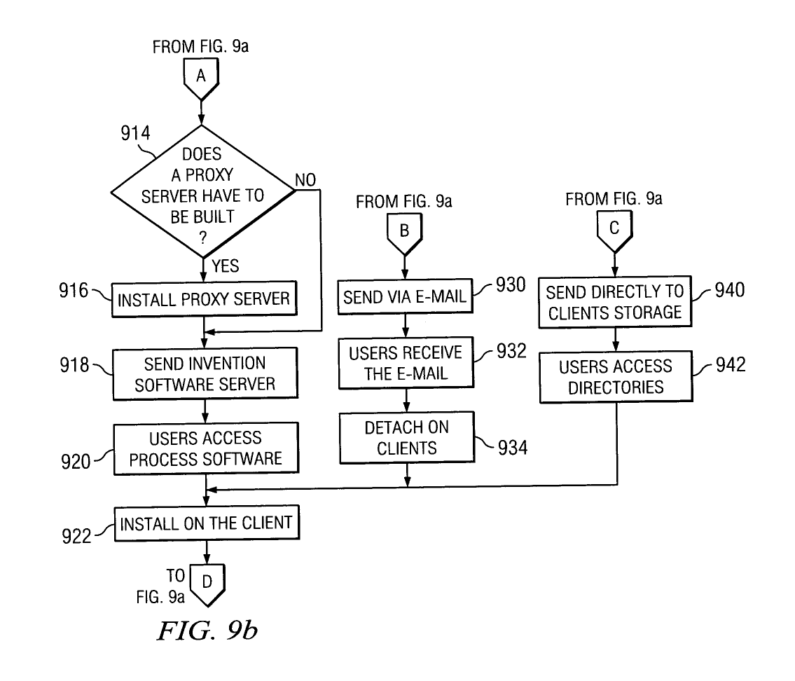

Thus, the method described in FIG. 3 can be deployed as a process software. Referring now to FIG. 9, step 906 begins the deployment of the process software. The first thing is to determine if there are any programs that will reside on a server or servers when the process software is executed (query block 902). If this is the case, then the servers that will contain the executables are identified (block 904). The process software for the server or servers is transferred directly to the servers' storage via File Transfer Protocol (FTP) or some other protocol or by copying though the use of a shared file system (block 906). The process software is then installed on the servers (block 908).

Next, a determination is made on whether the process software is be deployed by having users access the process software on a server or servers (query block 910). If the users are to access the process software on servers, then the server addresses that will store the process software are identified (block 912).

A determination is made if a proxy server is to be built (query block 914) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 916). The process software is sent to the servers either via a protocol such as FTP or it is copied directly from the source files to the server files via file sharing (block 918). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (block 920). Another embodiment is to have the servers automatically copy the process software to each client and then run the installation program for the process software at each client computer. The user executes the program that installs the process software on his client computer (block 922) then exits the process (terminator block 924).

In query step 926, a determination is made whether the process software is to be deployed by sending the process software to users via e-mail. The set of users where the process software will be deployed are identified together with the addresses of the user client computers (block 928). The process software is sent via e-mail to each of the users' client computers (block 930). The users then receive the e-mail (block 932) and then detach the process software from the e-mail to a directory on their client computers (block 934). The user executes the program that installs the process software on his client computer (block 922) then exits the process (terminator block 924).

Lastly a determination is made on whether to the process software will be sent directly to user directories on their client computers (query block 936). If so, the user directories are identified (block 938). The process software is transferred directly to the user's client computer directory (block 940). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 942). The user executes the program that installs the process software on his client computer (block 922) and then exits the process (terminator block 924).

VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process the of placing an entire packet within another packet and sending it over a network. The protocol of the outer packet is understood by the network and both points, called tunnel interfaces, where the packet enters and exits the network.

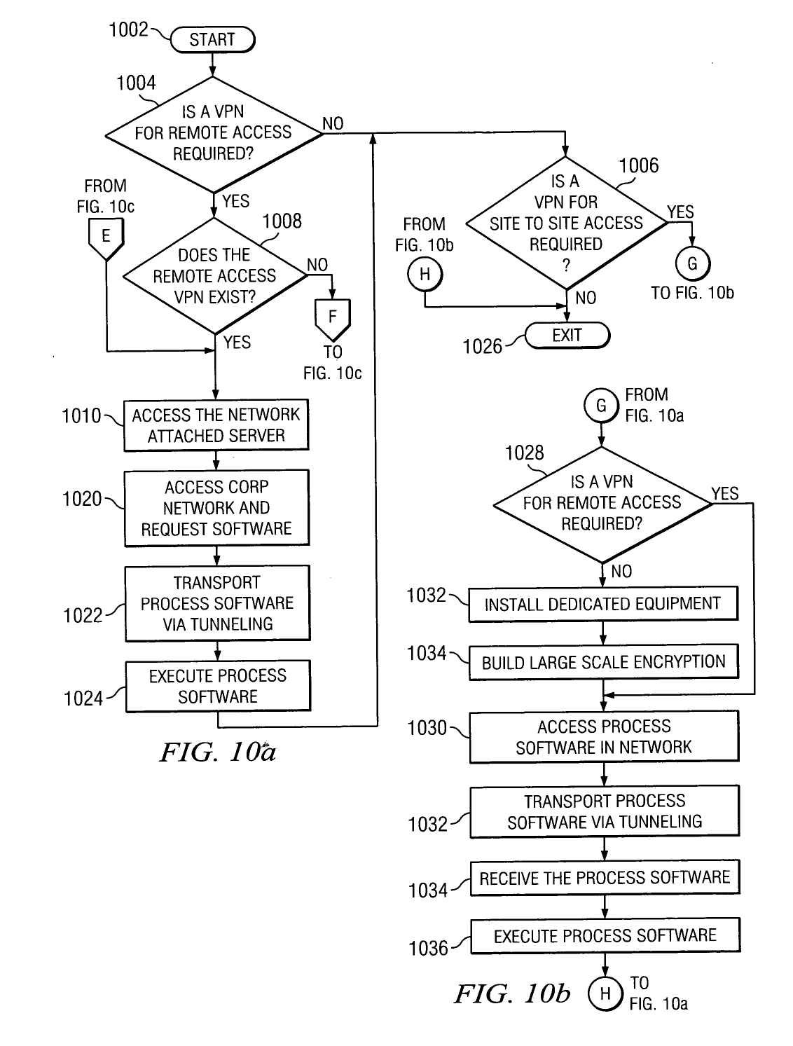

The process for such VPN deployment is described in FIG. 10. Initiator block 1002 begins the Virtual Private Network (VPN) process. A determination is made to see if a VPN for remote access is required (query block 1004). If it is not required, then proceed to (query block 1006). If it is required, then determine if the remote access VPN exists (query block 1008).

If a VPN does exist, then proceed to block 1010. Otherwise identify a third party provider that will provide the secure, encrypted connections between the company's private network and the company's remote users (block 1012). The company's remote users are identified (block 1014). The third party provider then sets up a network access server (NAS) (block 1016) that allows the remote users to dial a toll free number or attach directly via a broadband modem to access, download and install the desktop client software for the remote-access VPN (block 1018).

After the remote access VPN has been built or if it been previously installed, the remote users can access the process software by dialing into the NAS or attaching directly via a cable or DSL modem into the NAS (block 1010). This allows entry into the corporate network where the process software is accessed (block 1020). The process software is transported to the remote user's desktop over the network via tunneling. That is the process software is divided into packets and each packet including the data and protocol is placed within another packet (block 1022). When the process software arrives at the remote user's desktop, it is removed from the packets, reconstituted and then is executed on the remote users desktop (block 1024).

A determination is then made to see if a VPN for site to site access is required (query block 1006). If it is not required, then proceed to exit the process (terminator block 1026). Otherwise, determine if the site to site VPN exists (query block 1028). If it does exist, then proceed to block 1030. Otherwise, install the dedicated equipment required to establish a site to site VPN (block 1032). Then build the large scale encryption into the VPN (block 1034).

After the site to site VPN has been built or if it had been previously established, the users access the process software via the VPN (block 1030). The process software is transported to the site users over the network via tunneling (block 1032). That is the process software is divided into packets and each packet including the data and protocol is placed within another packet (block 1034). When the process software arrives at the remote user's desktop, it is removed from the packets, reconstituted and is executed on the site users desktop (block 1036). The process then ends at terminator block 1026.

Software Integration

The process software which consists code for implementing the process described in FIG. 3 may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

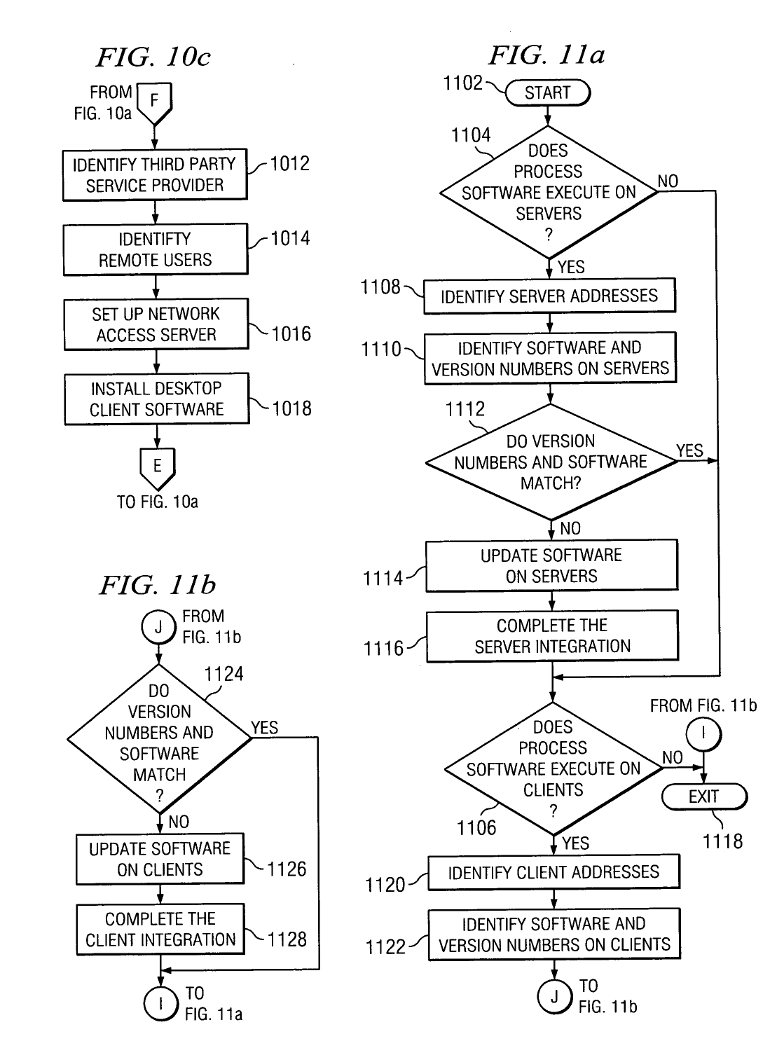

For a high-level description of this process, reference is now made to FIG. 11. Initiator block 1102 begins the integration of the process software. The first thing is to determine if there are any process software programs that will execute on a server or servers (block 1104). If this is not the case, then integration proceeds to query block 1106. If this is the case, then the server addresses are identified (block 1108). The servers are checked to see if they contain software that includes the operating system (OS), applications, and network operating systems (NOS), together with their version numbers, which have been tested with the process software (block 1110). The servers are also checked to determine if there is any missing software that is required by the process software in block 1110.

A determination is made if the version numbers match the version numbers of OS, applications and NOS that have been tested with the process software (block 1112). If all of the versions match and there is no missing required software the integration continues in query block 1106.

If one or more of the version numbers do not match, then the umnatched versions are updated on the server or servers with the correct versions (block 1114). Additionally if there is missing required software, then it is updated on the server or servers in the step shown in block 1114. The server integration is completed by installing the process software (block 1116).

The step shown in query block 1106, which follows either the steps shown in block 1104, 1112 or 1116 determines if there are any programs of the process software that will execute on the clients. If no process software programs execute on the clients the integration proceeds to terminator block 1118 and exits. If this not the case, then the client addresses are identified as shown in block 1120.

The clients are checked to see if they contain software that includes the operating system (OS), applications, and network operating systems (NOS), together with their version numbers, which have been tested with the process software (block 1122). The clients are also checked to determine if there is any missing software that is required by the process software in the step described by block 1122.

A determination is made is the version numbers match the version numbers of OS, applications and NOS that have been tested with the process software (query block 1124). If all of the versions match and there is no missing required software, then the integration proceeds to terminator block 1118 and exits.

If one or more of the version numbers do not match, then the unmatched versions are updated on the clients with the correct versions (block 1126). In addition, if there is missing required software then it is updated on the clients (also block 1126). The client integration is completed by installing the process software on the clients (block 1128). The integration proceeds to terminator block 1118 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

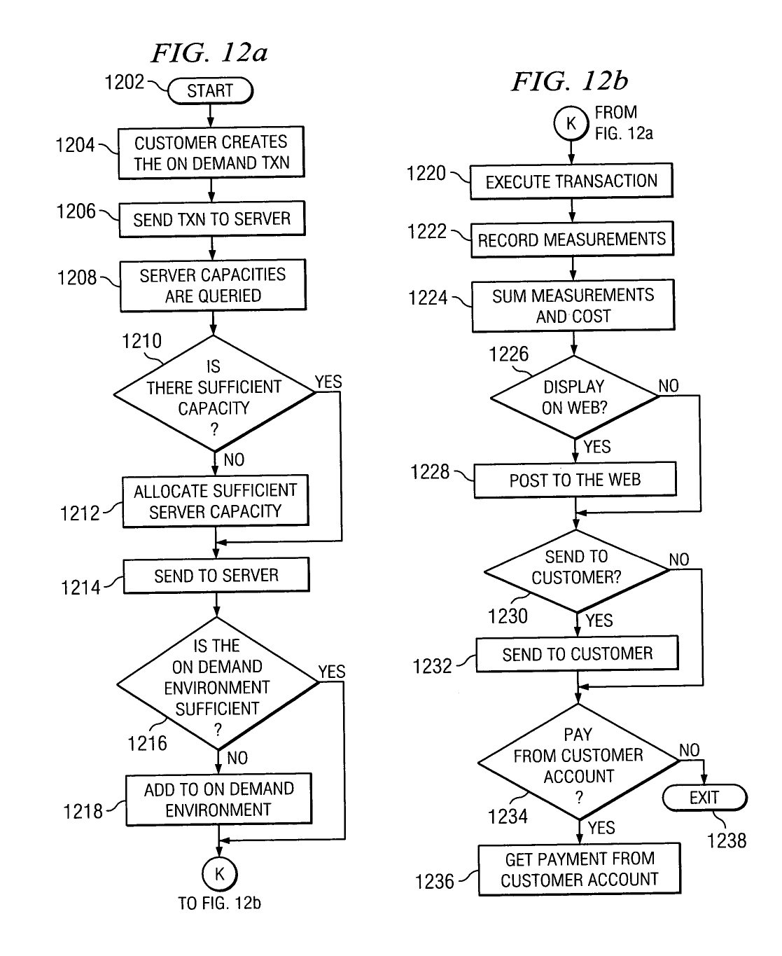

With reference now to FIG. 12, initiator block 1202 begins the On Demand process. A transaction is created than contains the unique customer identification, the requested service type and any service parameters that further specify the type of service (block 1204). The transaction is then sent to the main server (block 1206). In an On Demand environment the main server can initially be the only server, then as capacity is consumed other servers are added to the On Demand environment.

The server central processing unit (CPU) capacities in the On Demand environment are queried (block 1208). The CPU requirement of the transaction is estimated, then the servers available CPU capacity in the On Demand environment are compared to the transaction CPU requirement to see if there is sufficient CPU available capacity in any server to process the transaction (query block 1210). If there is not sufficient server CPU available capacity, then additional server CPU capacity is allocated to process the transaction (block 1212). If there was already sufficient Available CPU capacity then the transaction is sent to a selected server (block 1214).

Before executing the transaction, a check is made of the remaining On Demand environment to determine if the environment has sufficient available capacity for processing the transaction. This environment capacity consists of such things as but not limited to network bandwidth, processor memory, storage etc. (block 1216). If there is not sufficient available capacity, then capacity will be added to the On Demand environment (block 1218). Next the required software to process the transaction is accessed, loaded into memory, then the transaction is executed (block 1220).

The usage measurements are recorded (block 1222). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 1224).

If the customer has requested that the On Demand costs be posted to a web site (query block 1226), then they are posted (block 1228). If the customer has requested that the On Demand costs be sent via e-mail to a customer address (query block 1230), then these costs are sent to the customer (block 1232). If the customer has requested that the On Demand costs be paid directly from a customer account (query block 1234), then payment is received directly from the customer account (block 1236). The On Demand process is then exited at terminator block 1238.

The present invention thus provides an improved method, system and service for creating pre-determined, pre-negotiated and pre-arranged parameters for acquiring a resource, including manpower, manufacturing capacity, warehouse capacity, transportation, etc., by searching (preferably existing) databases. That is, by pre-defining protocols, practices, terms, pre-requisites, co-requisites, etc. for an agreement, a selecting entity and a resource provider are able to efficiently reach an agreement in which the resource provider provides the needed resource to the selecting entity. Thus, while the present invention has been described as securing a commitment from a skilled worker, the present invention can also be used to secure a commitment from any resource provider, including a provider of hardware, software, transportation, financial services (banking, insurance, et al.), communication bandwidth, energy, warehouse space, manufacturing resources, or any other service or commodity. The present invention provides an efficient method and system to search for a needed resource (including a worker), which when accepted, binds the resource provider and selecting entity in a deal pre-defined by the protocol of the system.

The present invention thus presents a method and system for engaging a worker on an assignment. The method includes pre-defined rules of engagement, explicit worker profiles comprised of attributes and information from multiple sources, and a process to a) search for worker candidates based on a “reasonable fit” between requirements of an assignment and worker profiles, b) assess the identified candidates through an evaluation and comparison of profiles, c) select and engage a worker for an assignment, and d) capture and post requirements for an assignment in the event that a qualified and available worker is not engaged. Furthermore, business rules and protocol are identified, negotiated and agreed to between entities with assignments and workers or their agents. These Rules of Engagement (ROE) may include policies, protocols, practices, commercial terms, and conditions that govern the transaction between an assignment (selecting) entity and a worker (and/or his representative workforce entity). The ROE outlines the set of requirements that must be met before a worker can make his/her services available for an assignment, and the protocols that must be satisfied by both the selecting entity and the workforce entity in order to commit a knowledge worker to an assignment. Since the ROE are prearranged, the process for searching, assessing and engaging a worker for an assignment by an entity can be immediate. In a preferred embodiment of the present invention, the search for a worker is performed by a search engine that is capable of selectively searching data sources of different unstructured labor pools, such that the search is capable of analysis of the content related to the workers, including such items as publications of workers in the database, to search for pre-selected key elements related to each worker's background.

While the invention has been particularly shown and described with reference to a preferred embodiment, it will be understood by those skilled in the art that various changes in form and detail may be made therein without departing from the spirit and scope of the invention.

What is claimed is:

1. A method for engaging a worker on an assignment, the method comprising:
establishing pre-defined rules of engagement;
obtaining explicit worker profiles using attributes and information from multiple sources;
searching for worker candidates based on a fit between requirements of an assignment and the explicit worker profiles;
assessing identified candidates through an evaluation and comparison of worker profiles;
selecting and engaging a worker for an assignment based on the evaluation and comparison of worker profiles; and
in response to a worker not being selected and engaged, capturing and posting an assignment for a worker for an assignment.

2. The method of claim 1, further comprising:
identifying, pre-negotiating and agreeing to business rules and protocol between an assignment entity and a workforce entity according to pre-declared Rules of Engagement, wherein the ROE include policies, protocols, practices, commercial terms and conditions that govern a transaction between the assignment entity and the workforce entity, and wherein the ROE outlines a set of requirements that must be met before a worker can make the worker's services available for an assignment, and wherein the protocols of the ROE must be satisfied by both the assignment entity and the workforce entity in order to commit a knowledge worker to an assignment, and wherein the ROE are prearranged such that a process for searching, assessing and engaging a worker for an assignment by a selecting entity is immediate.

3. The method of claim 1, wherein the search is performed by a search engine that is capable of selectively searching data sources of different unstructured labor pools, and wherein the search is capable of analysis of content related to workers, including content related to publications of workers in a database, to search for pre-selected key elements related to each worker's background.

4. The method of claim 3, wherein one of the conditions of the ROE is a length of a job position needing to be filled by the selecting entity.

5. The method of claim 3, wherein one of the conditions of the ROE is a starting date of a job position to be filled by the selecting entity.

6. The method of claim 3, wherein one of the conditions of the ROE is a salary range for the worker candidates.

7. The method of claim 3, wherein one of the conditions of the ROE is an experience requirement for the worker candidates.

8. The method of claim 3, wherein one of the conditions of the ROE is a location where the worker candidate is expected to work.

9. The method of claim 3, wherein one of the conditions of the ROE is an industry sector in which the selecting entity is classified.

10. The method of claim 2, further comprising:
in response to a failure to match a worker with an engagement posted by the selecting entity, posting a listing showing the assignment based on the rules of engagement, wherein the rules of engagement describe a set of job requirements for the assignment.

11. The method of claim 2, wherein a charge posted to an assignment entity is based on how quickly a job that is posted by the assignment entity is filled.

12. The method of claim 2, wherein a charge assessed against the assignment entity is based on a market demand for a worker meeting the rules of engagement.

13. The method of claim 1, wherein the method is performed by a service provider that is not the assignment entity.

14. A machine-readable medium having a plurality of instructions processable by a machine embodied therein, wherein said plurality of instructions, when processed by said machine causes said machine to perform a method comprising:
establishing pre-defined rules of engagement;
obtaining explicit worker profiles using attributes and information from multiple sources;
searching for worker candidates based on a fit between requirements of an assignment and the explicit worker profiles;
assessing identified candidates through an evaluation and comparison of worker profiles;
selecting and engaging a worker for an assignment based on the evaluation and comparison of worker profiles; and
in response to a worker not being selected and engaged, capturing and posting an assignment for a worker for an assignment.

15. The machine-readable medium of claim 14, wherein the method further comprises:
identifying, pre-negotiating and agreeing to business rules and protocol between an assignment entity and a workforce entity according to pre-declared Rules of Engagement, wherein the ROE include policies, protocols, practices, commercial terms and conditions that govern a transaction between the assignment entity and the workforce entity, and wherein the ROE outlines a set of requirements that must be met before a worker can make the worker's services available for an assignment, and wherein the protocols of the ROE must be satisfied by both the assignment entity and the workforce entity in order to commit a knowledge worker to an assignment, and wherein the ROE are prearranged such that a process for searching, assessing and engaging a worker for an assignment by a selecting entity is immediate.

16. The machine-readable medium of claim 14, wherein the search is performed by a search engine that is capable of selectively searching data sources of different unstructured labor pools, and wherein the search is capable of analysis of content related to workers, including content related to publications of workers in a database, to search for pre-selected key elements related to each worker's background.

17. The machine-readable medium of claim 15, wherein one of the conditions of the ROE is a length of a job position needing to be filled by the selecting entity.

18. The machine-readable medium of claim 15, wherein one of the conditions of the ROE is a starting date of a job position to be filled by the selecting entity.

19. The machine-readable medium of claim 15, wherein one of the conditions of the ROE is a salary range for the worker candidates.

20. The machine-readable medium of claim 15, wherein one of the conditions of the ROE is an experience requirement for the worker candidates.

21. The machine-readable medium of claim 15, wherein one of the conditions of the ROE is a location where the worker candidate is expected to work.

22. The machine-readable medium of claim 15, wherein one of the conditions of the ROE is an industry sector in which the selecting entity is classified.

23. The machine-readable medium of claim 15, wherein the method further comprises:
in response to a failure to match a worker with an engagement posted by the selecting entity, posting a listing showing the assignment based on the rules of engagement, wherein the rules of engagement describe a set of job requirements for the assignment.

24. The machine-readable medium of claim 15, wherein a charge posted to an assignment entity is based on how quickly a job that is posted by the assignment entity is filled.

25. The machine-readable medium of claim 15, wherein a charge assessed against the assignment entity is based on a market demand for a worker meeting the rules of engagement.

26. The machine-readable medium of claim 14, wherein the method is performed by a service provider that is not the assignment entity.

27. The machine-readable medium of claim 14, wherein the processable instructions are deployed to a server from a remote location.

28. The machine-readable medium of claim 14, wherein the processable instructions are provided by a service provider to a customer on an on-demand basis.

29. A service comprising:
populating a database with identities of available workers described by a plurality of worker attributes;
performing a faceted search of the database according to worker attributes selected by a selecting entity; and
in response to the selecting entity's search failing to find an available worker according to the selected worker attributes, posting, by the selecting entity through the third party administrator, a job posting.

30. The service of claim 29, wherein the job posting is accessible on an Internet.

31. The service of claim 29, wherein only job searchers that have been screened to confirm their qualifications are authorized to view the posted job posting.

32. The service of claim 29, wherein the third party administrator utilizes a search engine that searches different unstructured labor pools according to key words found in an available worker's posting.

33. The service of claim 31, wherein the available worker's posting is a webpage, and wherein the key words are found in a published document linked in the available worker's webpage posting.

34. The service of claim 32, wherein the third party administrator utilizes a search engine that searches different unstructured labor pools using context interpretation of wording found in an available worker's posting.

35. The service of claim 29, wherein the database is maintained by a third party administrator.
